(19) United States
(12) Patent Application Publication
(10) Pub. No.: US 2002/0190126 A1
(43) Pub. Date: Dec. 19, 2002

(54) Elecronic key reader

(76) Inventors: David Benhammou, Pantin (FR); Gerard Bonnefoy, Paris (FR)

Correspondence Address: GREENBLUM & BERNSTEIN, P.L.C., 1941 ROLAND CLARKE PLACE, RESTON, VA, 20191, US

(21) Appl. No.: 10/148,020

(22) PCT Filed: Dec. 7, 2000
(86) PCT No.: PCT/FR00/03423

(30) Foreign Application Priority Data
Jan. 5, 2000 (FR) 00/00072

(51) Int. Cl. G06K 7/08

(52) U.S. Cl. 235/451

(57) ABSTRACT

The invention concerns a reader for electronic keys comprising a protective metal housing, characterized in that it has, at least, a slot (5) extending from one of its edges to the center of its front surface (2).

The present invention concerns improvements relating to electronic key readers.

In the field of access controls, each authorized user has a badge provided with an electronic device which, once fed by an outside source, emits a coded signal allowing a door to open, for instance, when it is recognized by the reader.

The reader transmits the energy necessary to the functioning of the badge by a selfinductance coupling, which means that the reader and the badge both comprise an antenna that is in the form of a coil.

The reader is arranged on the exterior of the premises to which one controls access, and means preventing acts of vandalism need to be provided. Generally, the reader is enclosed in a very resistant metal housing that is solidly fixed to the frontage. The outer surface of this housing has slots to allow the flux from the antenna to radiate outward. In some cases, the reader is embedded and its front surface is protected by a metal plate.

Experiments have shown that, to be efficient, the badge should be placed relatively close to the reader, which is explained in that the metal housing, or the plate, acts like a turn that is traversed by the flux emitted by the antenna which absorbs part of the energy emitted by the latter by transforming it into heat.

The present invention, which overcomes this drawback, is remarkable in that the housing has a slot extending from one of the edges of the housing substantially to the center of the front surface of the latter.

The present invention will be better understood from the following description, with reference to the annexed drawings given only by way of example, and in which:

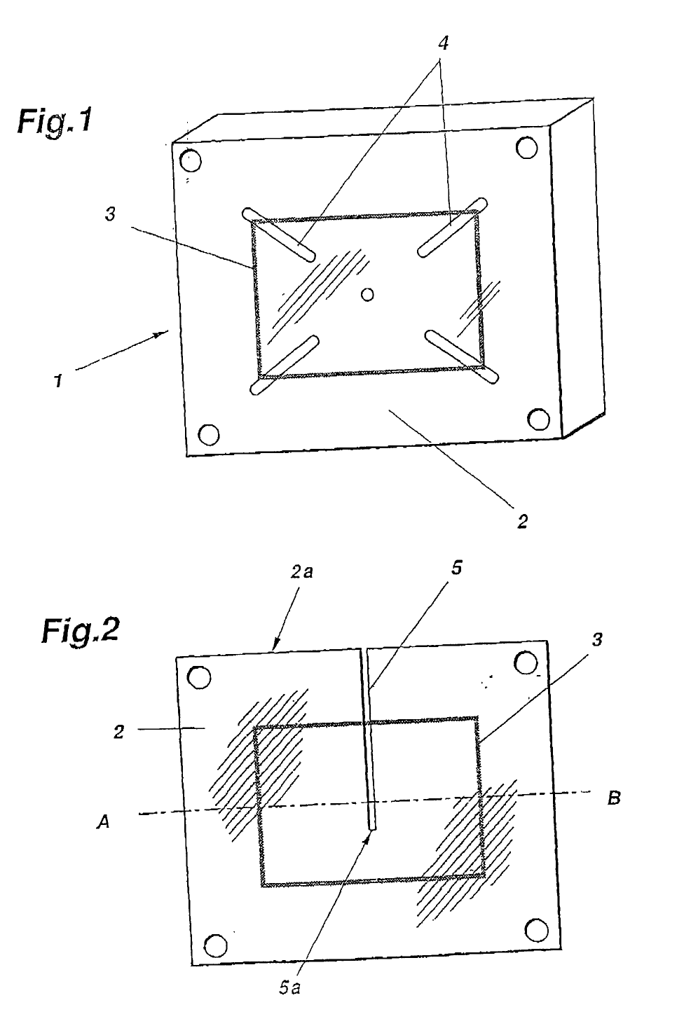

FIG. 1 is a perspective view of a known housing;

FIG. 2 is a front view of a housing according to the invention;

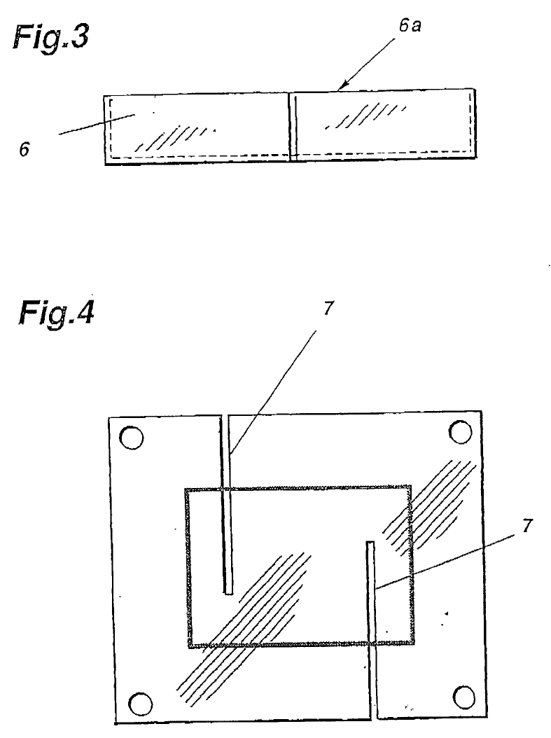

FIG. 3 is the top view of FIG. 2;

FIG. 4 is a view, similar to FIG. 2, showing an alternative embodiment.

In referring to FIG. 1, one can see that the reader is enclosed in a metal housing 1, behind the front surface 2 of which a common antenna, represented schematically by the loop 3, is arranged.

Openings 4 are provided on the surface 2 to allow the flux emitted by the loop 3 to exit. Experiments have shown that only a small portion of the energy radiated by the loop 2 was received by the user's badge, thus making it necessary for the latter to be relatively close to the reader.

This phenomenon is explained in that the housing acts like a self-inductance turn and absorbs part of the flux emitted by the antenna 3.

The present invention, which enables overcoming the aforementioned drawback, is remarkable in that the housing has a slot 5 extending from the edge 2a of the surface 2 to the center of said surface, said slot extending over the lateral surface 6 of the housing to open out on its field 6a.

When the housing is limited to a metal plate covering the reader, which is embedded, the aforementioned slot opens out on any one of the sides of said plate.

Experiments have shown that the effect of absorption resulting from the metal housing was substantially reduced by the single presence of the slot 5 of FIG. 2, therefore making it possible for a user to be recognized even though he is at a distance from the reader that is much greater than the one at which he was previously.

Naturally, nothing contradicts providing openings similar to those 4 on the front surface of the reader.

The result of the invention can be improved by providing several slots, such as those 7 of FIG. 4.

Preferably, the end 5a of the slot 5 extends beyond the median line AB that connects the middle of the sides adjacent to the one which said slot opens out on.

1. Electronic key reader comprising a protective metal housing (1), characterized in that it has, at least, one slot (5) extending from one (6a) of its edges to the center of its front surface (2).

2. Reader, according to claim 1, in which the protective housing is limited to its front surface, and therefore is in the form of a plate, characterized in that the slot (5) opens out on any one of the sides of said plate.

3. Reader, according to any of claims 1 and 2, characterized in that the end (5a) of the slot (5) extends beyond the median line connectiing the sides adjacent to the one which said slot opens out on.
